(19) United States
(12) Patent Application Publication
(10) Pub. No.: US 2022/0341787 A1
(43) Pub. Date: Oct. 27, 2022

(54) HIGH-SENSITIVITY, NON-CONTACT CHROMATICITY MEASUREMENT DEVICE

(71) Applicant: ANI. Co. Ltd, Suwon-si, Gyeonggi-do (KR)

(72) Inventors: Byung Jun OH, Suwon-si, Gyeonggi-do (KR); Kyu Ho LEE, Anyang-si, Gyeonggi-do (KR); Kyu Seok KIM, Suwon-si, Gyeonggi-do (KR); Hyun Ho LEE, Seoul (KR); Ki Beom NA, Suwon-si, Gyeonggi-do (KR); Sung Hyuk YOON, Anyang-si, Gyeonggi-do (KR)

(73) Assignee: ANI. Co. Ltd, Suwon-si, Gyeonggi-do (KR)

(21) Appl. No.: 17/763,654

(22) PCT Filed: Nov. 12, 2020
(86) PCT No.: PCT/KR2020/015835

§ 371 Date: Mar. 25, 2022

(30) Foreign Application Priority Data
Nov. 13, 2019 (KR) 10-2019-0144961

(51) Int. Cl. G01J 3/50; G01J 3/02

(52) U.S. Cl. CPC G01J 3/506; G01J 3/0218; G01J 3/0208

(57) ABSTRACT

A high-sensitive contactless chromaticity measuring device according to the present invention, includes: a lens unit to receive light emitted from a measurement object; a light distribution unit including an optical fiber to receive the light passing through the lens unit and distribute the received light through n paths to output the light to the other side, wherein a numerical aperture is greater than a predetermined reference value, a condensing lens to reduce an incidence angle of the light output to the other side of the optical fiber to a target angle or more, and n color filters to transmit different wavelengths of the light passing through the condensing lens; and a signal conversion unit including a photodiode to convert the light transmitted from the light distribution unit into an electrical signal.

### TECHNICAL FIELD

The present invention relates to a contactless chromaticity measuring device, and more particularly, to a high-sensitive contactless chromaticity measuring device that is provided with a condensing lens for reducing an incidence angle of light to apply an optical fiber having a high numerical aperture, thereby measuring the chromaticity of a measurement object having extremely low luminance.

### BACKGROUND ART

Currently, the global monitor market is rapidly changing from CRTs to LCD monitors and from LCDs to LED monitors. In particular, as the demand for large-sized LED monitors increases, the production volume is rapidly increasing.

As the production volume of such displays increases, the production quality also acts as one of important factors, and devices for determining whether there are defects or not have been developed. In particular, chromaticity measuring devices for measuring whether a color expressed in a display such as an LCD or LED accurately represents a color to be actually output have been developed.

A general chromaticity measuring device is configured to measure the color of light incident through a detection sensor consisting of a photodiode, and measures the color by contacting the measurement object.

However, when the color is measured while the measurement object and the chromaticity measuring device are in contact with each other as described above, there is a problem in that since the measurement time is increased, and thus productivity is reduced.

Accordingly, in order to improve such a problem, a contactless chromaticity measuring device for measuring the chromaticity in remote while being not in contact with the measurement object has been developed.

In the case of the contactless chromaticity measuring device, since the measurement is performed while the measurement object is spaced at a long distance, there is an advantage that the measurement rate is fast, but there is a problem in that the measurement accuracy for relatively low luminance is lowered.

In order to improve such a problem, it is necessary to further increase the amount of light incident into the contactless chromaticity measuring device.

As a method for this, there may be a method of increasing the amount of light by increasing a numerical aperture (N/A) of an optical fiber provided inside the contactless chromaticity measuring device to receive light in a wide range of angles and a method of increasing the amount of light by increasing an area of an incident part of the optical fiber.

Like the former case, in the case of increasing the numerical aperture of the optical fiber, since a color filter provided in the contactless chromaticity measuring device is a dichroic filter, there is a phenomenon that the transmittance shifts to a short wavelength band according to an incidence angle. Since the phenomenon affects XYZ spectroscopic characteristics of the color filter, there is a problem in that an error occurs in the measurement result.

In addition, like the latter case, when the area of the incident part of the optical fiber is increased, an area of an output part of the optical fiber becomes larger than that of the photodiode, resulting in loss of light, and the measurement angle per point of the measured light source increases, causing problems in chromaticity measurement.

Therefore, there is a need for a method for solving these problems.

### DISCLOSURE

### Technical Problem

The present invention is derived to solve the problems of the related art, and an object of the present invention is to provide a contactless chromaticity measuring device having a structure capable of measuring chromaticity of a measurement object having extremely low luminance by greatly increasing the amount of incident light, but correcting a measurement result so that an error does not occur.

The objects of the present invention are not limited to the aforementioned objects, and other objects, which are not mentioned above, will be apparently understood to those skilled in the art from the following description.

### Technical Solution

According to an aspect of the present invention, a high-sensitive contactless chromaticity measuring device includes a lens unit to receive light emitted from a measurement object, a light distribution unit including an optical fiber to receive the light passing through the lens unit and distribute the received light through n paths to output the light to the other side, wherein a numerical aperture is greater than a predetermined reference value, a condensing lens to reduce an incidence angle of the light output to the other side of the optical fiber to a target angle or less, and n color filters to transmit different wavelengths of the light passing through the condensing lens, and a signal conversion unit including a photodiode to convert the light transmitted from the light distribution unit into an electrical signal.

The light distribution unit may further include a micro-array lens that is provided between the condensing lens and the color filter to compensate for the light passing through the condensing lens so that a spectroscopic transmittance is not changed.

In addition, n micro-array lenses may be provided to correspond to n paths of the optical fiber, respectively.

The micro-array lens may be formed to have an area corresponding to an output area of all of the n paths of the optical fiber.

In addition, n condensing lenses are provided to correspond to n paths of the optical fiber, respectively.

Meanwhile, a reference value of the numerical aperture of the optical fiber may be formed to be 0.2 or more.

The lens unit may be formed of a telecentric lens that receives only parallel light.

The high-sensitive contactless chromaticity measuring device may further include a signal amplification unit to amplify the electrical signal converted by the signal conversion unit to transmit the amplified electrical signal to an external system.

### Advantageous Effects

According to the present invention, since the contactless chromaticity measuring device may compensate for a difference in transmittance according to a high incidence angle of light incident to an optical fiber having a high numerical aperture when measuring luminance and chromaticity through a condensing lens and a micro-array lens, there are advantages of greatly improving accuracy of measurement of luminance and chromaticity and precisely measuring chromaticity even for a measurement object having extremely low luminance.

The effects of the present invention are not limited to the aforementioned effect, and other effects not mentioned above will be clearly understood to those skilled in the art from the description of the appended claims.

### DESCRIPTION OF DRAWINGS

FIG. 1 is a view illustrating a state in which chromaticity of a measurement object is measured by a high-sensitive contactless chromaticity measuring device according to a first embodiment of the present invention;

FIG. 2 is an exploded view illustrating respective components of the high-sensitive contactless chromaticity measuring device according to the first embodiment of the present invention;

FIG. 3 is a view schematically illustrating an internal structure of the high-sensitive contactless chromaticity measuring device according to the first embodiment of the present invention;

FIG. 4 is a view illustrating main parts of a light distribution unit and a signal conversion unit in the high-sensitive contactless chromaticity measuring device according to the first embodiment of the present invention;

FIG. 5 is a view illustrating a path of light incident on an optical fiber;

FIG. 6 is a view illustrating a shift amount of a central wavelength according to an incidence angle;

FIG. 7 is a view illustrating a difference in spectroscopic profile according to the presence or absence of a micro-array lens in the same optical system;

FIG. 8 is a view illustrating an appearance of a high-sensitive contactless chromaticity measuring device according to a second embodiment of the present invention;

FIG. 9 is a view illustrating an appearance of a high-sensitive contactless chromaticity measuring device according to a third embodiment of the present invention; and

FIG. 10 is a view illustrating an appearance of a high-sensitive contactless chromaticity measuring device according to a fourth embodiment of the present invention.

### BEST MODE

Hereinafter, preferred embodiments of the present invention, in which an object of the present invention may be realized in detail, will be described with reference to the accompanying drawings. In describing the embodiments, the same names and the same reference numerals will be used with respect to the same components and the resulting additional description will be omitted.

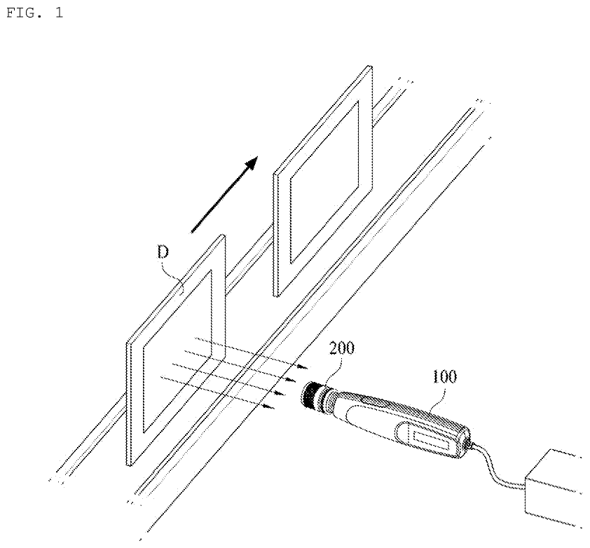

FIG. 1 is a view illustrating a state in which chromaticity of a measurement object D is measured by a high-sensitive contactless chromaticity measuring device according to a first embodiment of the present invention, and FIG. 2 is an exploded view illustrating respective components of the high-sensitive contactless chromaticity measuring device according to the first embodiment of the present invention.

As illustrated in FIG. 1, the high-sensitive contactless chromaticity measuring device according to the first embodiment of the present invention is disposed to be spaced apart from a measurement object D to detect light emitted from the measurement object D and measure the chromaticity therefor.

In addition, as illustrated in FIG. 2, the high-sensitive contactless chromaticity measuring device according to the first embodiment of the present invention includes a case 100 in which an accommodation space is formed, a lens unit 200 that is mounted on one side of the case to receive the light emitted from the measurement object D, a light distribution unit 400 that distributes and corrects the light passing through the lens unit 200, a signal conversion unit 300 that converts the light transmitted from the light distribution unit to an electrical signal, and a signal amplification unit 500 that amplifies the electrical signal converted by the signal conversion unit to transmit the amplified electrical signal to an external system.

In this case, the lens unit 200 may include a telecentric lens unit 210 and a lens connection unit 220 to receive only collimated light, that is, parallel light parallel to an optical axis.

In addition, in the embodiment, the light distribution unit 400, the signal conversion unit 300, and the signal amplification unit 500 are provided in the accommodation space inside the case 100, and the lens unit 200 has a form provided to be exposed to one side of the case. However, this is only one embodiment, and of course, the appearance and the connection structure of the high-sensitive contactless chromaticity measuring device according to the present invention may be formed in various ways.

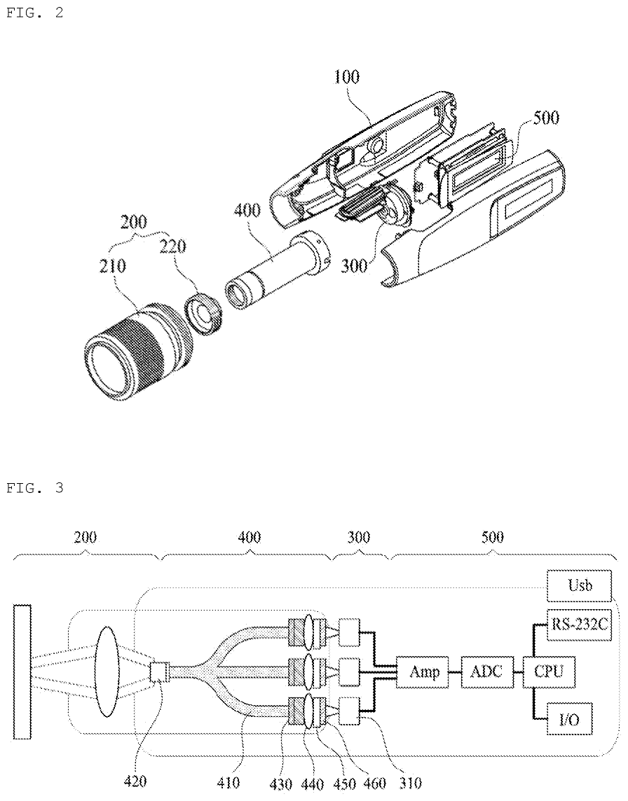

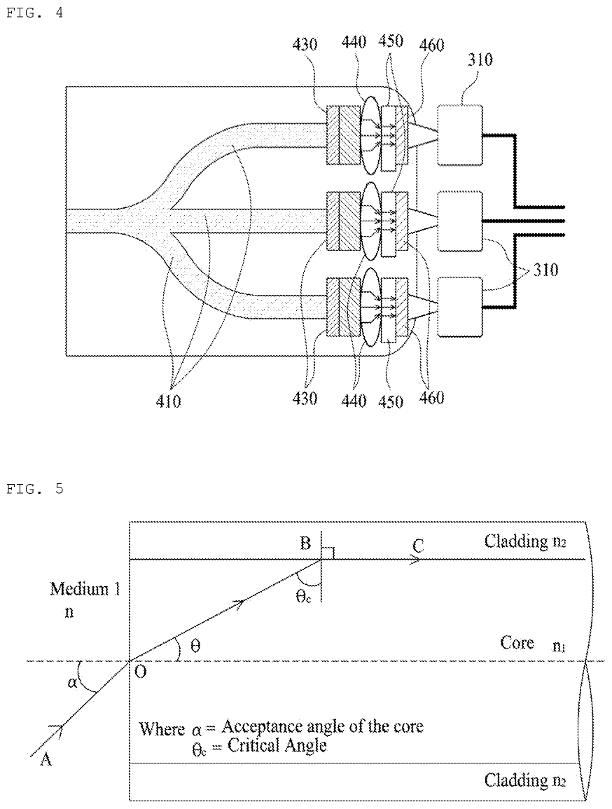

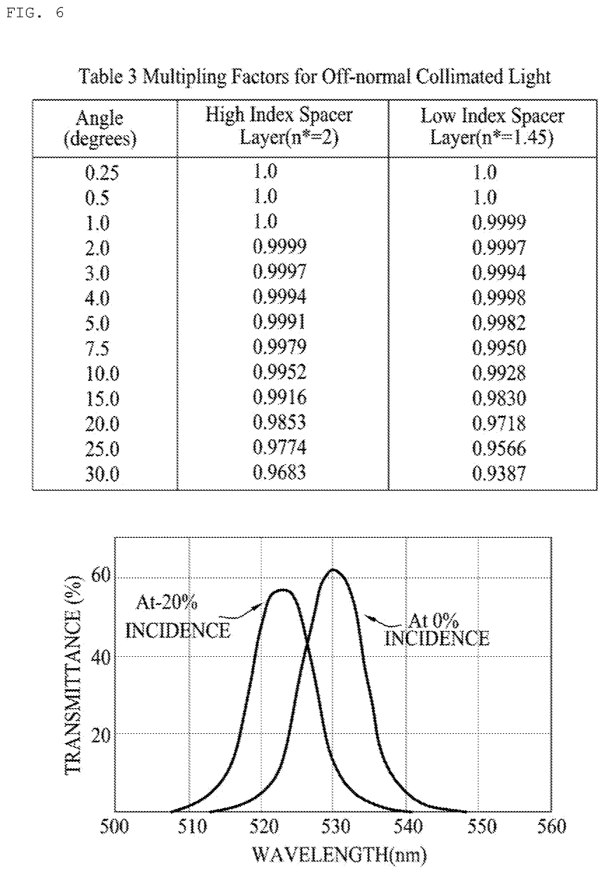

FIG. 3 is a view schematically illustrating an internal structure of the high-sensitive contactless chromaticity measuring device according to the first embodiment of the present invention and FIG. 4 is a view illustrating main parts of the light distribution unit 400 and the signal conversion unit 300 in the high-sensitive contactless chromaticity measuring device according to the first embodiment of the present invention.

As illustrated in FIGS. 3 and 4, in the high-sensitive contactless chromaticity measuring device according to the first embodiment of the present invention, the lens unit 200, the light distribution unit 400, the signal conversion unit 300, and the signal amplification unit 500 are sequentially disposed.

The lens unit 200 receives the light emitted from the measurement object D to transmit the received light to the light distribution unit 400.

In addition, the light distribution unit 400 includes an optical fiber 410, a condensing lens 440, a micro-array lens 450, and a color filter 460.

The optical fiber 410 is a component that receives the light passing through the lens unit 200 from one side, distributes the received light through n paths, and outputs the light to the other side. To this end, a light input unit 420 is formed on one side of the optical fiber 410, and a light output unit 430 is formed on the other side of the optical fiber 410.

In addition, in the embodiment, the optical fiber 410 has a form of distributing and outputting the received light into three paths, but the number of distributed paths is not limited thereto and may be variously determined.

As described above, in the embodiment, the light to be lost may be minimized by applying the optical fiber 410 to the light distribution unit 400, and according to the characteristics of the optical fiber 410 which may be flexibly bent, it is not necessary to dispose the light distribution unit 400 and the signal conversion unit 300 in a straight line, so that the space utilization may be increased.

In addition, the optical fiber 410 may have a numerical aperture (N/A) greater than a predetermined reference value. The reason therefor is to further increase the amount of light incident to the inside of the contactless chromaticity measuring device, thereby improving the measurement accuracy for low luminance.

For example, the reference value of the numerical aperture of the optical fiber 410 may be 0.2 or more, and in the embodiment, it is exemplified that the optical fiber 410 having a numerical aperture of 0.5 is applied.

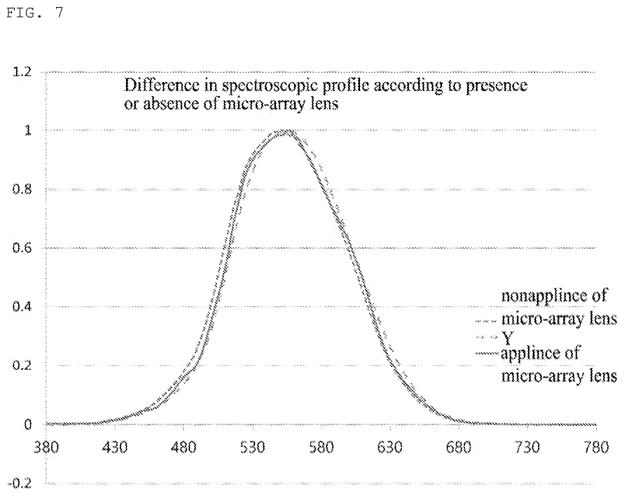

However, when the reference value of the numerical aperture of the optical fiber 410 is formed to be 0.2 or more as described above, since the color filter 460 to be described below is a dichroic filter, a phenomenon that the transmittance shifts to a short wavelength band according to an increase in the incident angle may occur (see FIGS. 5 and 6). Since the phenomenon affects XYZ spectroscopic characteristics of the color filter 460, there is a problem in that an error occurs in the measurement result.

Accordingly, in the embodiment, there were provided the condensing lens 440 for reducing the incidence angle of the light output to the other side of the optical fiber 410 to a target angle or less, and the micro-array lens 450 provided between the condensing lens 440 and the color filter 460 to compensate for the light passing through the condensing lens 440 so that the spectroscopic transmittance is not changed.

The condensing lens 440 collects light emitted by the optical fiber 410 through which light is transmitted at a high incidence angle to correct the light to an incidence angle of a target angle or less, and the micro-array lens 450 compensates for the light converged through the condensing lens 440 to prevent the transmittance for each wavelength from being changed. Here, the target angle of the condensing lens 440 may be 5°.

Meanwhile, n condensing lenses 440 and micro-array lenses 450 may be provided to correspond to n paths of the optical fiber 310, respectively. In the embodiment, since the optical fiber 310 distributes light through three paths, a total of three condensing lenses 440 and micro-array lenses 450 are also provided to have a form provided to correspond to each light output unit 430 of the optical fiber 310.

However, this is only a form applied in the embodiment, and the number and the area of condensing lenses 440 and micro-array lenses 450 may be applied to a form other than the embodiment.

Unlike the embodiment, when the micro-array lens 450 and an optical fiber bundle are not matched at 1:1, the dispersion of light occurs to reduce a deviation of light incident at a high angle.

In addition, the light distribution unit 400 further includes n color filters 460 for transmitting different wavelengths of the light passing through the condensing lens 440 and the micro-array lens 450.

Specifically, the color filter 460 receives the transmitted light to transmit only light of a specific wavelength, and as described above, the color filter 460 of the embodiment is a dichroic filter.

The dichroic filter is a filter that filters out waves of a specific wavelength by using an interference phenomenon occurring on a thin film, and may be divided into several types depending on a method of obtaining a desired wave and a type of filter material.

The signal conversion unit 300 includes a photodiode 310 that converts the light transmitted from the light distribution unit 400 into an electrical signal.

The photodiode 310 is a component that detects a color through the light transmitted from the light distribution unit 400, and may be configured by at least one photodiode.

Specifically, the photodiode 310 is a kind of sensor that receives light and converts the light into an electrical signal and receives the light passing through the color filter 460 and converts the light into an electrical signal. The received electrical signal is used to measure the color of the light received by a separate external system.

In addition, the signal amplification unit 500 is a component that amplifies the electrical signal converted by the signal conversion unit 300 and transmits the amplified electrical signal to an external system, and since it is obvious to those skilled in the art, the description for the signal amplification unit 500 will be omitted.

As described above, according to the present invention, since it is possible to compensate for a difference in transmittance according to a high incidence angle of light incident to the optical fiber 410 having a high numerical aperture when measuring luminance and chromaticity through the condensing lens 440 and the micro-array lens 450, it is possible to greatly improve the accuracy of measurement of luminance and chromaticity and to precisely measure the chromaticity even for a measurement object having extremely low luminance.

Meanwhile, a CIE 1931 XYZ color space (or CIE 1931 color space) is one of the first color spaces defined mathematically based on research on human color perception.

In the human eye, there are cone cells, which are receptors for three types of light of short wavelength, medium wavelength, and long wavelength, and accordingly, in principle, the human sense of color may be expressed by three variables.

A tristimulus value refers to a combination that may create the same color as a desired color by combining three primary colors in an additive color mixture model, and these tristimulus values are mainly expressed as X, Y, and Z values in the CIE 1931 color space.

That is, various display devices are ultimately used by humans, and evaluates chromaticity based on the human eye, and may be better equipment as the output value of a colormeter is closer to a CIE 1931 graph, which is the standard of the human eye.

In the present invention, light passing through the center of the lens unit 200 is incident to the optical fiber at 0°, but light passing through the outside of the lens unit 200 is incident at a predetermined high angle (e.g., 30°). That is, as the size of a sample to be measured increases, the angle of the incident light increases. In this case, the micro-array lens 450 may change the light incident at a high angle to be close to 0° or disperse the light at 0° and 30° to a wide angle.

As a result, since a difference in angle of light disappears depending on the size of the sample and there is no difference in the angle of light, the amount of change in the spectroscopic profile (CIE 1931) is reduced.

In addition, in order to verify this fact, the following process may be performed.

First, equipment (hereinafter referred to as a monochromator) capable of emitting monochromatic wavelengths (e.g., output only light of 400 nm and 401 nm) is prepared, and light from 380 nm to 780 nm is output from the monochromator at intervals of 1 nm (e.g., output light of 380 nm, and output light of 381 nm after 1 second).

Thereafter, the light output through the chromaticity measuring device of the present invention is measured and recorded each time, and then the recorded values are expressed as a graph and compared with the CIE 1931 graph.

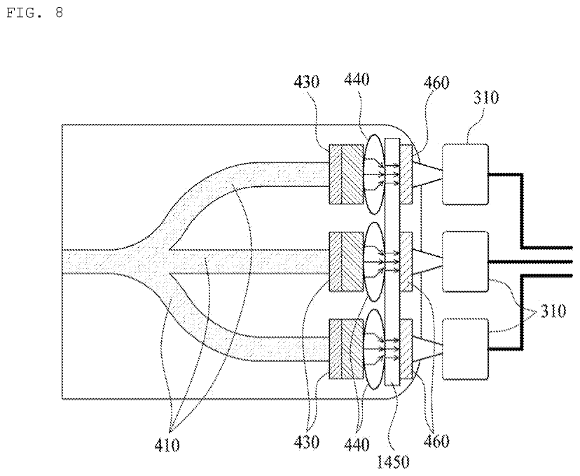

FIG. 7 is a view illustrating a spectroscopic profile difference according to the presence or absence of the micro-array lens 450 in the same optical system.

Referring to a graph shown in FIG. 7 derived through the above process, when the micro-array lens 450 is added to the same optical system, it may be confirmed that the graph is closer to a Y graph which is a reference compared to an optical system in a state in which the micro-array lens 450 is not provided.

Hereinafter, other embodiments of the present invention will be described.

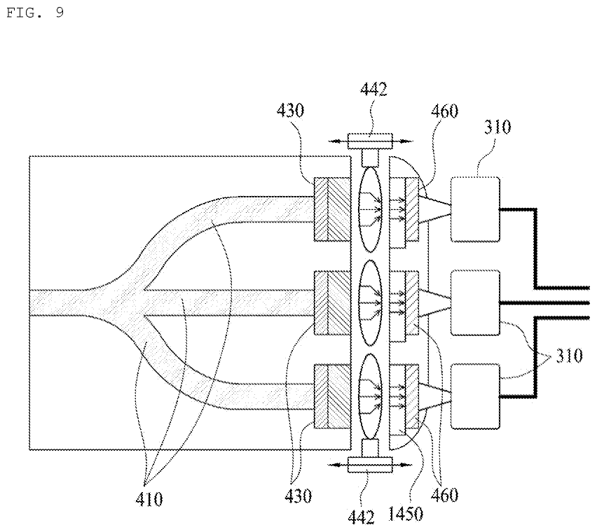

FIG. 8 is a view illustrating an appearance of a high-sensitive contactless chromaticity measuring device according to a second embodiment of the present invention.

In the case of the high-sensitive contactless chromaticity measuring device according to a second embodiment of the present invention illustrated in FIG. 8, the second embodiment is different form the first embodiment described above in that a micro-array lens 1450 is formed to have an area corresponding to an output area of all n paths of the optical fiber 310.

That is, in the embodiment, a single micro-array lens 1450 has an area corresponding to the output area of all three paths of the optical fiber 310, and in this case, the micro-array lens 1450 may also be formed to have a different transmission characteristic for each area.

In addition, like the micro-array lens 1450, of course, the condensing lens 440 may also be formed to have an area corresponding to the output area of all n paths of the optical fiber 310.

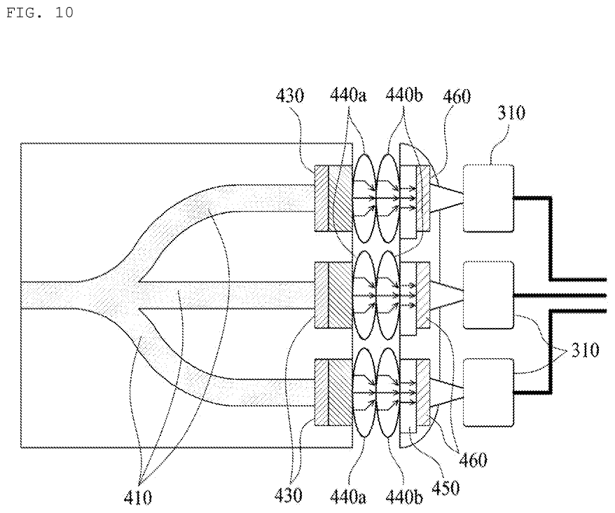

FIG. 9 is a view illustrating an appearance of a high-sensitive contactless chromaticity measuring device according to a third embodiment of the present invention.

In the case of the third embodiment of the present invention illustrated in FIG. 9, a spaced distance between the light output unit 430 and the micro-array lens 450 of the optical fiber 310 is greater than the thickness of the condensing lens 440, and the condensing lens 440 is formed to be linearly movable between the light output unit 430 and the micro-array lens 450 of the optical fiber 310 by a linear movement module 442.

In this case, since the condensing degree of light may be adjusted by adjusting the position of the condensing lens 440 according to a numerical aperture of the optical fiber 310, there is an advantage that it is possible to replace and apply the optical fiber 310 suitable for a situation.

FIG. 10 is a view illustrating an appearance of a high-sensitive contactless chromaticity measuring device according to a fourth embodiment of the present invention.

The fourth embodiment of the present invention illustrated in FIG. 10 has a feature in that condensing lenses 440a and 440b are arranged in multiple stages.

Specifically, the embodiment includes a first condensing lens 440a that forms a first group adjacent to the light output unit 430 between the light output unit 430 and the micro-array lens 450 of the optical fiber 310, and a second condensing lens 440b that forms a second group adjacent to the micro-array lens 450.

In this case, since the incidence angle of light may be further reduced by the condensing lenses 440a and 440b arranged in a multi-stage structure, there is an advantage of applying the optical fiber 410 having a higher numerical aperture.

As described above, the prepared embodiment of the present invention has been as described, and in addition to the embodiments described above, a fact that the present invention can be materialized in other specific forms without departing from the gist or scope thereof will be apparent to those skilled in the art. Therefore, the aforementioned embodiments are not limited but should be considered to be illustrative, and accordingly, the present invention is not limited to the above description and may be modified within the scope of the appended claims and a range equivalent thereto.

### EXPLANATION OF REFERENCE NUMERALS AND SYMBOLS

100: Case

200: Lens unit

300: Signal conversion unit

310: Photodiode

400: Light distribution unit

410: Optical fiber

440: Condensing lens

450: Micro-array lens

460: Color filter

500: Signal amplification unit

1. A high-sensitive contactless chromaticity measuring device comprising:
a lens unit to receive light emitted from a measurement object;
a light distribution unit including an optical fiber configured to receive the light passing through the lens unit and distribute the received light through n paths to output the light to the other side, wherein a numerical aperture is greater than a predetermined reference value, a condensing lens configured to reduce an incidence angle of the light output to the other side of the optical fiber to a target angle or more, and n color filters configured to transmit different wavelengths of the light passing through the condensing lens; and
a signal conversion unit including a photodiode configured to convert the light transmitted from the light distribution unit into an electrical signal.

2. The high-sensitive contactless chromaticity measuring device of claim 1, wherein the light distribution unit further includes a micro-array lens that is provided between the condensing lens and the color filter to compensate for the light passing through the condensing lens so that a spectroscopic transmittance is not changed.

3. The high-sensitive contactless chromaticity measuring device of claim 2, wherein n micro-array lenses are provided to correspond to n paths of the optical fiber, respectively.

4. The high-sensitive contactless chromaticity measuring device of claim 2, wherein the micro-array lens is formed to have an area corresponding to an output area of all of the n paths of the optical fiber.

5. The high-sensitive contactless chromaticity measuring device of claim 1, wherein n condensing lenses are provided to correspond to n paths of the optical fiber, respectively.

6. The high-sensitive contactless chromaticity measuring device of claim 1, wherein a reference value of the numerical aperture of the optical fiber is formed to be 0.2 or more.

7. The high-sensitive contactless chromaticity measuring device of claim 1, wherein the lens unit is formed of a telecentric lens that receives only parallel light.

8. The high-sensitive contactless chromaticity measuring device of claim 1, further comprising:
a signal amplification unit configured to amplify the electrical signal converted by the signal conversion unit to transmit the amplified electrical signal to an external system.
